(19) United States
(12) Patent Application Publication
(10) Pub. No.: US 2004/0261774 A1
(43) Pub. Date: Dec. 30, 2004

(54) Gas-assisted internal combustion engine

(76) Inventor: Neil Wallace Eft, Alliance, OH (US)

Correspondence Address: Neil W. Eft, 1001 W. Milton St., Alliance, OH, 44601, US

(21) Appl. No.: 10/602,705

(22) Filed: Jun. 25, 2003

(51) Int. Cl. F02M 25/07

(52) U.S. Cl. 123/568.13; 123/58.8

(57) ABSTRACT

A gas-assisted internal combustion engine has been invented which is capable of using energy stored in high pressure primary and reserve reservoirs in the form of compressed gas during normal operation and calling on that energy to provide additional power during start-up, acceleration and high demand requirements.

### BACKGROUND OF THE INVENTION

The development of Otto and Diesel cycle engines has reached a plateau defined by physical limitations. Specific fuel consumption has not decreased substantially, with most improvement arising from improvement in accessory equipment and component weight. In order to provide a reserve for acceleration and increased power on demand the installed horsepower in an automobile may be several times that required to propel it at desired speeds. As a result the engine in an autombile traveling at normal speeds is usually not performing at optimum specific fuel consumption.

### SUMMARY OF THE INVENTION

Supplementary pressurized gas is provided to an internal combustion engine to increase power for acceleration or increased load requirements. A small amount of gas is bled from the cylinder each time it reaches peak pressure and is stored in a primary reservoir at high pressure. If the control system detects a need for additional power gas from the primary reervoir is injected into the cylinder on the power stroke, increasing the mean effective pressure and power output. A reserve reservoir containing any suitable gas at higher pressure can supplement the primary reservoir in emergency conditions.

### DESCRIPTION OF DRAWINGS

FIG. 1: The sequence of events during the compression and power strokes of a gas-assisted internal combustion engine.

FIG. 2: The configuration of components which produce the events in FIG. 1

### DETAILED DESCRIPTION OF THE INVENTION

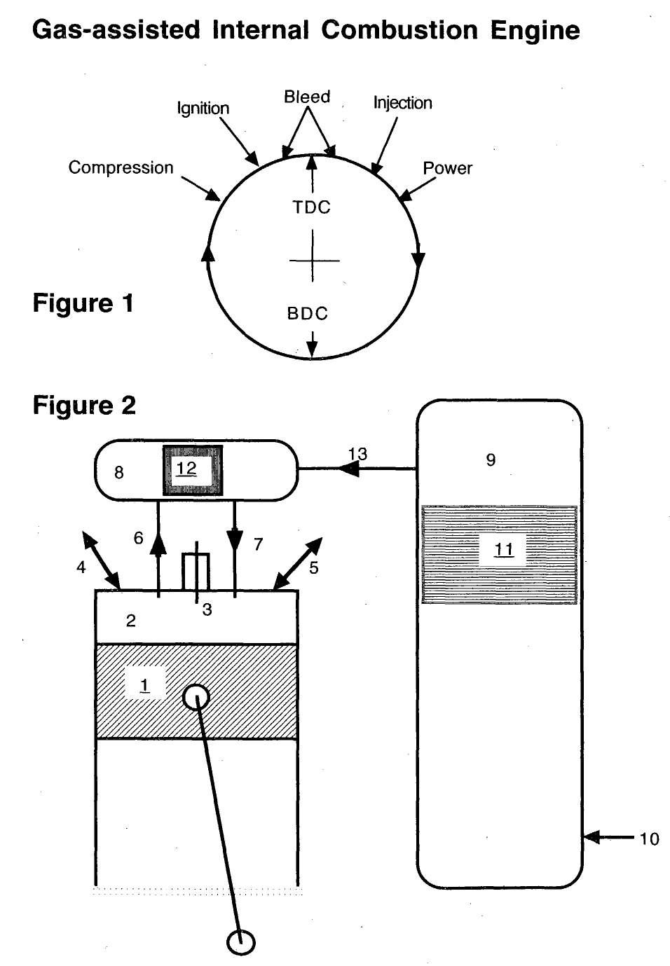

FIG. 1 shows the 360 degrees of crankshaft travel which includes the compression and power strokes of an internal combustion engine.

In the Otto cycle during the compression and power strokes, intake valve (4) and exhaust valve (5) are closed and air and vaporized fuel are compressed in cylinder (2) by the upward travel of piston (1), reaching its maximum compression at top dead center (TDC). Ignition is supplied, typically by a spark plug (3), at some point before TDC. Combustion of the fuel creates a rapid rise in temperature and pressure, forcing the piston (1) into the downward power stroke, causing the crankshaft to rotate and the piston to move into the next compression stroke.

In the Diesel cycle, during the compression and power strokes, intake valve (4) and exhaust valve (5) are closed and air is compressed in cylinder (2) by the upward travel of piston (1), reaching its maximum compression at top dead center (TDC). Fuel is injected into the hot compressed air at a point ahead of TDC followed by ignition, combustion and a rapid rise in pressure, forcing piston (1) into the downward power stroke, causing the crankshaft to rotate and the piston to move into the next upward stroke. An ignition source may be used but is usually not required since combustion occurs spontaneously as the fuel contacts the hot high pressure air.

In both the Otto and Diesel cycles, as the piston moves through top dead center (TDC), a small portion of hot, high pressure gas is bled off on each power stroke through check valve (6) into primary reservoir (8) until the reservoir reaches maximum pressure. In a few power strokes the pressure in primary reservoir (8) will reach peak pressure and will maintain that pressure until the control system opens injection valve (7).

If the control system detects a demand for power to maintain speed or provide acceleration it will open injection valve (7) and supply valve (13) each time the piston reaches a designated point or internal pressure and inject high pressure gas from reserve reservoir (9) or primary reservoir (8) into the cylinder for a period of time set by the control system. The injected gas maintains the pressure in the cylinder during the power stroke in proportion to the amount of gas injected. No additional fuel is required to achieve a burst of power for acceleration or increase in load.

The gas in primary reservoir (8) is at or near the same pressure and temperature as the gas in the cylinder at peak pressure. It can be heated to a higher temperature by an external heat source or by an optional heat exchanger (12) prior to injection in order to further improve performance.

The injection gas in reserve reservoir (9) can also be heated by an optional heat exchanger (11) to increase both its temperature and pressure prior to injection. Heat exchanger (11) can use a separate heat source or counter-flow heat exchange with the products of combustion exhausted from cylinder (2). Reserve reservoir (9) can be intermittently recharged at location (10) with a suitable gas whenever its static pressure falls to a level where it can no longer contribute to system performance.

1. An internal combustion engine in which gas from an auxiliary source is introduced to assist, enhance or substitute for the products of combustion normally used to power the engine.

2. An engine, as in claim 1, in which gases produced in the cylinder at high pressure during the ignition phase are bled into an auxiliary reservoir and are reintroduced into the cylinder at a lower pressure and at a later point in the power stroke.

3. An engine, as in claim 1, in which gas from a separate source is stored in a reserve reservoir at pressures above those in the primary reservoir and the engine cylinder, to inject into the primary reservoir or directly into the cylinder, on demand.

4. An engine, as in claim 2, in which any cylinders of a multi-cylinder engine serve a single primary reservoir from which any designated cylinders can draw high pressure injection gas for operation.

5. An engine, as in claim 2, in which a reserve reservoir is preheated by an external source or a heat exchanger to increase its injection pressure and thereby improve performance.

6. An engine, as in claim 2, in which any cylinders of a multi-cylinder engine can operate on the Otto or Diesel cycle and the remaining cylinders can operate with auxiliary gas injection at any load percentage desired by the operator.

7. An engine, as in claim 2, in which one or more cylinders operate in a lean-fuel or no-fuel condition, primarily for the purpose of maintaining the primary reservoir in a fully charged condition.

8. An engine, as in claim 2, in which the operation of exhaust and intake valves, fuel input and injected gas input are under computer control so that the optimum time and amount of gas injection can be attained.

9. An engine, as in claim 3, in which all or a portion of the gas stored in the reserve reservoir undergoes a solid, liquid, or gaseous phase change.

10. An engine, as in claim 3, in which the gas stored in the reserve reservoir is air, steam, sulfur dioxide, carbon dioxide, products of combustion, or mixtures thereof.

11. An engine, as in claim 3, in which the gas stored in the reserve reservoir contains combustible components.

12. An engine, as in claim 3, in which one or more cylinders are designed for a higher compression ratio so as to supply the gas stored in the primary and reserve reservoirs.

13. An engine, as in claim 2, in which the primary reservoir is of sufficient size to support engine operation without a reserve reservoir.

14. An engine, as in claim 2, in which the primary reservoir is omitted and the reserve reservoir injects gas directly into the cylinder.

15. An engine, as in claim 2, in which both the primary and reserve reservoirs operate at a pressure at or below the peak pressure attained in the cylinder so that gas is injected into the cylinder later in the power stroke and at a reduced pressure.

16. An engine, as in claim 2, in which an excess of fuel is introduced into the cylinder, said excess being combusted by high pressure air or oxygen injected into the cylinder from the primary or reserve reservoirs on the power stroke.

17. An engine, as in claim 2, in which either the primary or reserve reservoir serves to inject gas directly into the cylinder during the power stroke to provide an easy-start feature.

18. An engine, as in claim 2, in which fuel is supplied to selected cylinders with the remaining cylinders operating to pump gas into the primary or reserve reservoirs.
